(19) United States
(12) Patent Application Publication
(10) Pub. No.: US 2025/0292234 A1
(43) Pub. Date: Sep. 18, 2025

(54) MANUAL GAME CONTROLLER WITH CRYPTOGRAPHIC HARDWARE WALLET

(71) Applicant: Shaga Labs, Inc., Dover, DE (US)

(72) Inventors: Guido Rocco PARDINI, Viareggio (IT); Aaron STERNBERG, Phoenix, AZ (US); Daeshawn BALLARD, Baltimore, MD (US)

(21) Appl. No.: 19/076,864

(22) Filed: Mar. 11, 2025

Related U.S. Application Data
(60) Provisional application No. 63/566,695, filed on Mar. 18, 2024.

(51) Int. Cl. G06Q 20/36; A63F 13/23; G06F 21/86; G06Q 20/40; H04L 9/00

(52) U.S. Cl. CPC G06Q 20/3674; A63F 13/23; G06F 21/86; G06Q 20/40145; H04L 9/50; H04L 2209/56

(57) ABSTRACT

A Web3 gamepad contains a secure element to hold the user's cryptographic identity to access their accounts with just the gamepad. These accounts are not limited to Web2 accounts, such as Netflix or Steam, but include Web3 accounts, to allow players to store access keys to a blockchain (NFTs . . . etc). The secure element can be removable if integrated into a hardware wallet module that is matable to the gamepad to allow for portability and compatibility with laptop/desktop, and to be able to substitute the gamepad in the event of accidental damage, without substituting the wallet.

### RELATED APPLICATION

This application claims priority benefit of U.S. Provisional Patent Application No. 63/566,695 filed Mar. 18, 2024, which is hereby incorporated by reference in its entirety.

### TECHNICAL FIELD

This disclosure relates generally to manual game controllers and, more particularly, to gamepads for facilitating cryptographic (or simply, crypto) transactions.

### BACKGROUND INFORMATION

A manual controller is any type of device that can be used to control a display. One type of manual controller is a remote control. Some remote controllers are used to interact with a game presented on the display, in which case the remote controller acts as a game controller. Game controllers can be used with any smart device—such as, for example, a PC, laptop, phone, tablet, VR headset, or other types of displays—that can present a game and allow for inputs from a controller. One type of game controller is a gamepad, which is a type of video game controller held in two hands, where the fingers (especially thumbs) are used to provide input. These are typically the main input device for video game consoles. Other types of controllers can be held in one hand as well, for those people who might not have the use of two hands.

One form of cryptographic hardware is a hardware wallet, which contains a secure element (SE). A hardware wallet is a physical device designed to securely store cryptocurrency private keys offline, protecting them from online hacking attempts. Unlike software wallets that reside on a computer or smartphone, hardware wallets provide an extra layer of security by keeping the private keys completely isolated from internet-connected devices. Transactions are signed within the hardware wallet and then broadcasted to the network, minimizing the risk of theft. This makes hardware wallets one of the safest options for storing and managing cryptographic keys.

Ledger SAS focuses on providing secure hardware wallets for cryptocurrencies and digital assets. The company products include the Ledger Nano X, Ledger Nano S Plus, and Ledger Stax, designed to securely manage crypto and NFTs. It also offers the Ledger Live app, which acts as a companion for the hardware wallet, allowing users to buy, sell, swap, stake, and manage their digital assets. The company's website mentions security, control, and the ability to support over 5,500 coins and tokens, catering to both beginners and experienced users in the crypto space.

Trezor company s.r.o. is another company in the cryptocurrency security space, also providing hardware wallet products. Its products are designed to offer secure, offline storage for various cryptocurrencies, aiming to enhance the safety and privacy of users' digital assets. By focusing on hardware wallets, Trezor provides a physical layer of protection against online threats, emphasizing user control and ownership of private keys. Their offerings cater to both beginners and experienced users in the cryptocurrency community.

The D'CENT wallet is available from IoTrust Co., Ltd. The company's technology attempts to provide a comprehensive solution for cryptocurrency management, emphasizing safety and convenience. The product range includes a biometric wallet, a card-type wallet, and a software wallet, all of which can be managed through a mobile app. The company focus is on providing enhanced crypto protection based on the security standards, aiming to cater to the needs of users looking for secure, versatile options for managing their digital assets.

Various companies offer mobile game controllers. Examples include 8BitDo Pro 2, GuliKit KingKong 2 Pro, GameSir T4 Mini, Backbone One, GameSir X2 Pro, SteelSeries Stratus+, PowerA Moga XP-5 X, Backbone One PlayStation Edition, Nacon MG-X Pro, Sony DualSense Controller, Microsoft Xbox Wireless Controller (White), Nintendo Switch Pro Controller, Keymander 2 Mobile, and others.

Some controllers have integrated biometric sensor (e.g., fingerprint reader). One example is Dell's NYX controller concept. Other examples attempt to monitor the player's autonomic nervous system through peripheral signals like heart rate and perspiration. This data, combined with in-game actions, helps analyze the player's mood and reactions, potentially enabling game adjustments for enhanced engagement or to ensure children take breaks. Such technology, not entirely new in gaming, opens possibilities for games that dynamically respond to the player's emotional and physical state.

In order to transact with a hardware wallet, a user connects that hardware wallet into an internet-enabled device (through a secure application) to prepare, broadcast, and confirm a transaction on the blockchain network. If the user is using a manual controller that is connected directly to a smartphone or tablet, the hardware wallet becomes cumbersome to use because the user would have to remove the manual controller from the smartphone and either hold it or put it down somewhere in order to retrieve the hardware wallet and then connect the hardware wallet in order to conduct a blockchain transaction, thereby causing significant interruption of the gameplay session, while also adding additional wear and tear to the data port of the smartphone or tablet.

A gameplay session can also be materially interrupted if the manual controller is wirelessly connected to the smartphone or tablet, or laptop or VR device. When playing blockchain games on a television, it would be inconvenient to stop gameplay, get up from a couch or chair, put down the controller, retrieve the hardware wallet, walk to the TV, connect it, and have to see what is on the TV and then maneuver either to the side of the TV or back where the hardware wallet would have to connect to approve a blockchain transaction on the hardware wallet to purchase something in the game, and then walk back to the couch or chair and sit down and start playing again. Further, TVs are not designed with the same level of security and isolation for sensitive operations as computers or smartphones that are regularly updated and equipped with security features specifically for financial transactions or managing digital assets.

Although the latest smartphones include both TEE and cryptographic hardware, which also include hardware that could be used to store blockchain transaction keys such as an SE, a smartphone company locks the SE for only specific use for the company's own financial transaction system. This does not allow access to the SE for users to store their own secure keys needed for authorization of blockchain transactions. The same is true with tablets, although SEs are not as prevalent in tablets as they are in smartphones. The same is true with laptops, although typically only high-end laptops include SEs. Current VR and & AR devices do not contain cryptographic hardware. Most televisions worldwide do not include cryptographic hardware capable of storing blockchain keys.

### SUMMARY OF THE DISCLOSURE

Considering the above, in order to conduct the most secure blockchain transaction, a user would have to connect a hardware wallet to a personal device, desktop, or television, which would completely disrupt the user's game playing session. In contrast, a manual controller (for manipulating images or symbols on a display) includes integrated cryptographic hardware that can process (i.e., receive unsigned and then sign) blockchain or other crypto transactions. It optionally includes a trusted execution environment (TEE). The disclosed controller gives a user an added layer of security, flexibility, and convenience when playing games that cannot be achieved when playing games without this manual controller on a television, or a standard personal gaming device (e.g., a smartphone, tablet, laptop, or VR device). These embodiments facilitate game streaming for Web3/blockchain games, since it was previously not possible to use other devices since cryptography key pairs cannot be safely imported into another device capable of streaming games, for security reasons. The disclosed embodiments allow for importing the blockchain transactions right from the game hosting machine and allow for secure signatures in the SE in the hardware wallet of the gamepad, securing all the gamer's assets with a modular wallet.

When playing games on a personal device or television using a manual controller including a TEE and integrated cryptographic hardware that can store blockchain keys, a user may, respectively, authenticate and sign cryptocurrency transactions without having material disruption to the game that the user is playing. An additional embodiment of this controller has the integrated cryptographic hardware removable. Since cryptographic hardware can also contain the secret keys to access blockchain accounts, where Web3 game assets whose ownership is recorded on blockchain ledgers, a user could take the removable cryptographic hardware from the manual controller and lend it to a friend so the friend can play with the user's assets, or the user can sell the cryptographic hardware outright, without having to sell the gamepad.

Having a hardware wallet integrated into a manual controller allows the user to bypass the need for a smartphone/laptop/desktop/tablet (personal device), and connect to a TV while still maintaining a high level of security and not disrupting gameplay. This gives the user the ability to play games that are Web3 and purchase content in the game, only with a controller and TV, reducing the complications of also managing a personal device during the process of transacting in a Web3 game on a television, or having to connect a hardware wallet directly to the television.

The disclosed game controller can store a user's most valuable data (blockchain secret keys) in the safest of ways: a hardware wallet. The SE, hardware security module (HSM), trusted platform module (TPM), programmable smartcards, or other cryptographic hardware in the hardware wallet is not limited to blockchain-only secret keys, but can store any kind of cryptographic curve/secret key, allowing for the gamepad to be used to sign-in into the user's accounts, after they have been accessed for the first time and their credentials are saved onto the gamepad. Additionally, the controller may support authentication into Web2 services, such as Epic Games, Steam, PlayStation Network, and Xbox Live, allowing the user to securely log in using credentials stored in the TEE. The controller could also function as a FIDO2 authentication device for secure login to banking apps, government portals, and online services, eliminating the need for manual password entry. This is not only possible with the hardware wallet module of the gamepad embodiments, but it is also possible to have offline signatures of transactions, such as depositing amounts from another hardware wallet to the gamepad wallet. The transaction would be signed by the device and submitted toward the blockchain by the gamepad and its relative application presented on any display supporting a connection to the internet. This allows users more flexibility and grants them the ability to safely interact with preexisting wallets.

In addition to supporting cryptocurrency transactions, the disclosed game controller can also handle conventional fiat currency financial transactions, e.g., through Visa, Mastercard, and EMV-based systems. This integration allows users to purchase in-game content, digital services such as Netflix and PlayStation Store, and even physical goods using a single device. Secure biometric authentication, such as fingerprint scanning, ensures that only the authorized user can approve financial transactions.

Another advantage of the disclosed embodiments is the ability to remove the hardware wallet from the manual controller in order to use the hardware wallet separately on a personal device or to lend or sell the hardware wallet to a friend or buyer, without having to give up use of the gamepad.

Another advantage of the disclosed embodiments is the ability to store zero-knowledge biometric data in the manual controller's TEE, outside the hardware wallet's SE. This allows the user of the manual controller to remove the hardware wallet from the manual controller and still be able to authenticate the user's identity using biometric data such as a fingerprint that is stored in the manual controller's TEE.

For smart TVs and streaming devices, which often lack built-in secure payment hardware, the disclosed controller enables transactions without requiring a smartphone or laptop. Using the secure display on the hardware wallet, users can review and approve transactions securely, reducing the risk of inputting sensitive payment information on an untrusted device.

Another advantage of the disclosed embodiments is the presence of physical on/off switches for the wallet. Without these and being always connected to the gamepad, that could potentially lead to unwanted or malicious transactions being signed. If the physical switch for the controller is off, not a single transaction can be signed by the hardware wallet, because the physical switch will be effectively stopping the flow of electrical current into the hardware wallet module.

Additional aspects and advantages will be apparent from the following detailed description of embodiments, which proceeds with reference to the accompanying drawings.

### BRIEF DESCRIPTION OF THE DRAWINGS

To easily identify the discussion of any particular element or act, the most significant digit or digits in a reference number refer to the figure number in which that element is first introduced.

FIG. 1 is a set of top and bottom plan views of a manual game controller in accordance with one embodiment.

FIG. 2A and FIG. 2B are, respectively, left- and right-side portions of an annotated flow chart of a process for using the manual game controller of FIG. 1 to sign transactions in accordance with one embodiment.

FIG. 3 is an annotated flow chart of a process for using the manual game controller of FIG. 1 to disable and enable an airgap mode in accordance with one embodiment.

FIG. 4 is an annotated flow chart of a process for using the manual game controller of FIG. 1 to enable the airgap mode for non-Web3 experience in accordance with one embodiment.

FIG. 5 is a set of isometric views of a gamepad system including a gamepad and a removable hardware wallet module in accordance with another embodiment.

FIG. 6 is a block diagram showing how the removable hardware wallet module may be coupled to a laptop in accordance with one embodiment.

FIG. 7 is a block diagram showing the gamepad system communicating with a display interface (game client) for Web3 game streaming in accordance with one embodiment.

FIG. 8 is a message sequence diagram for completing a crypto transaction with the gamepad system in accordance with one embodiment.

FIG. 9 is a block diagram showing the gamepad system authenticating and signing crypto transactions during game streaming using, respectively, a TEE in the gamepad and keys stored in the removable hardware wallet module in accordance with one embodiment.

FIG. 10 is a block diagram showing the gamepad system authenticating with the TEE, which may be used separately from signing crypto transactions with the removable hardware wallet module in accordance with one embodiment.

FIG. 11 is a flow chart of a process for enabling secure blockchain transactions in a gaming environment, performed by a manual game controller in accordance with one embodiment.

FIG. 12 is a block diagram of a computing device, according to one embodiment.

### DETAILED DESCRIPTION OF EMBODIMENTS

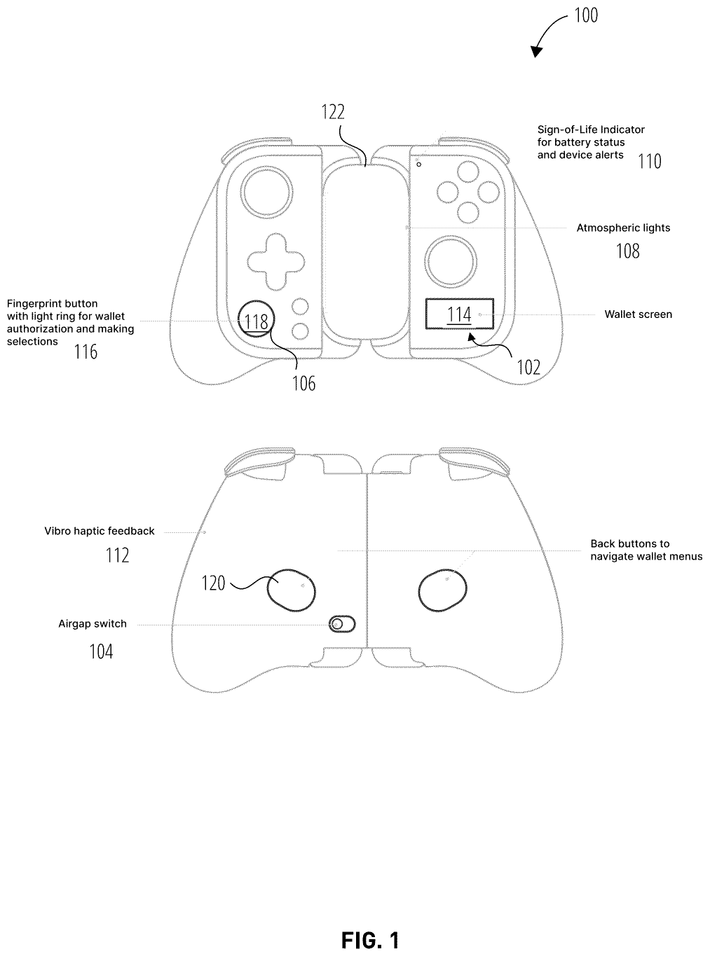

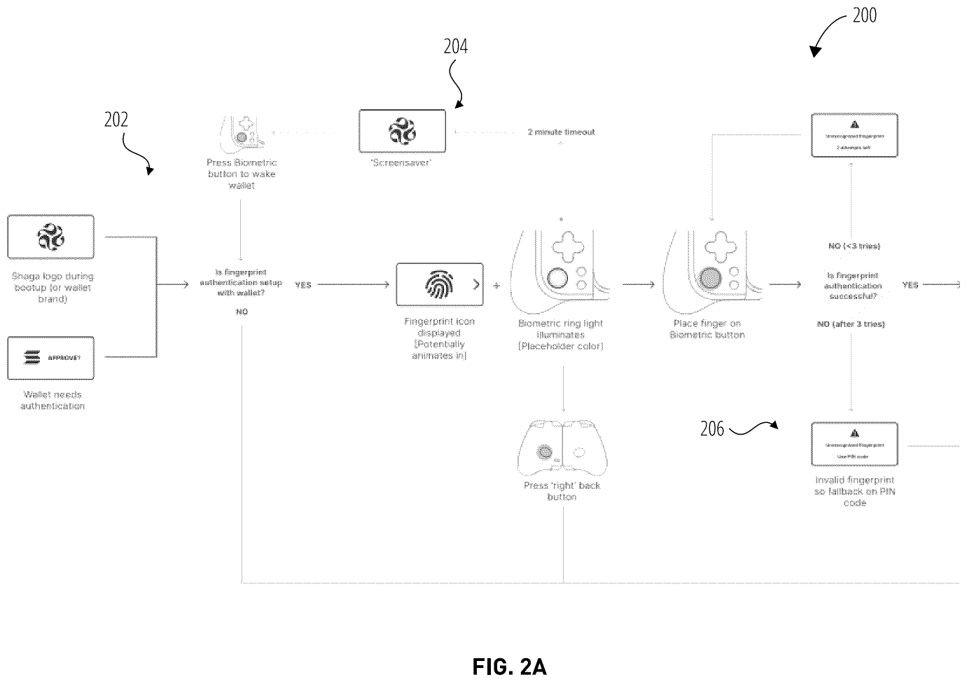

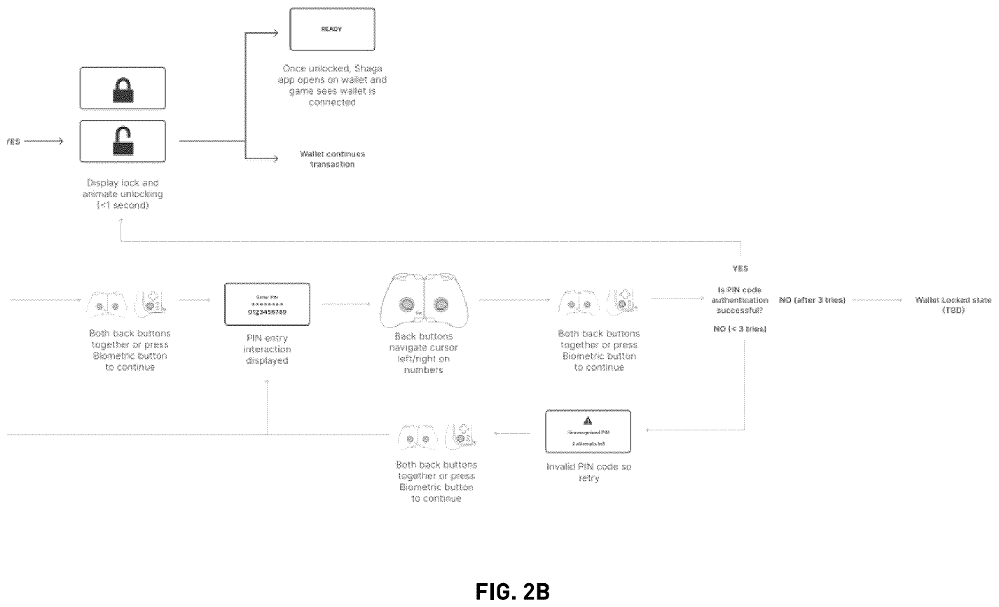

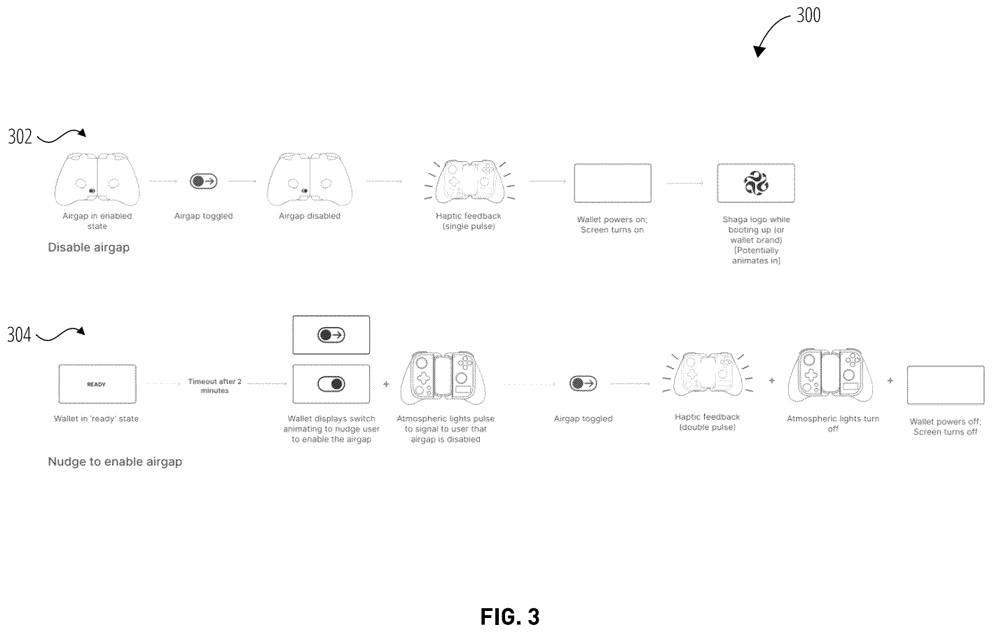

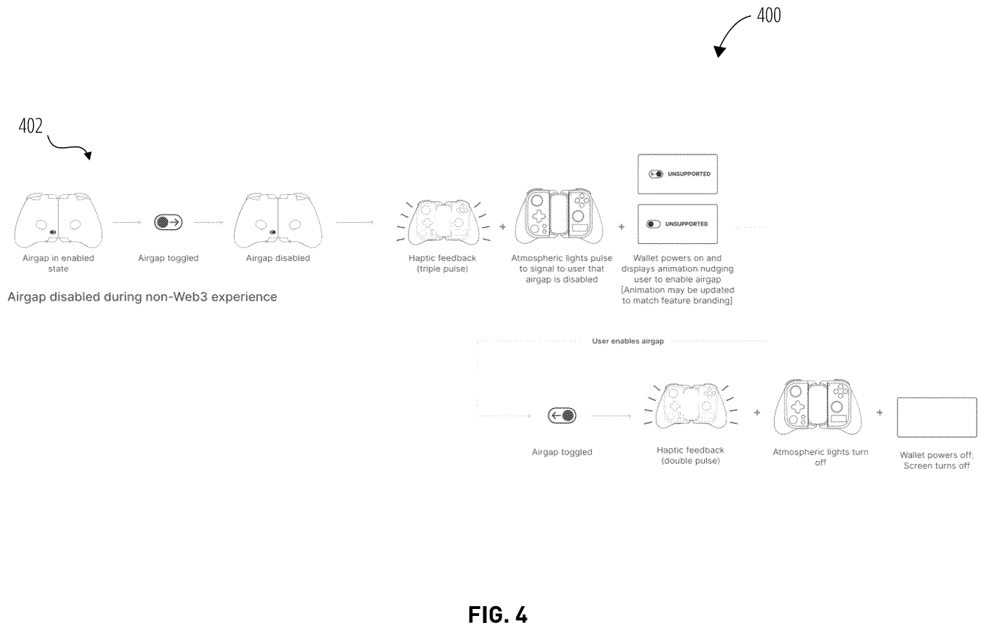

FIG. 1 shows an example of a manual game controller 100 that integrates a cryptographic hardware wallet 102, enabling secure blockchain and conventional financial transactions while maintaining a seamless user experience. The figure depicts both the front and rear views of manual game controller 100, annotating components involved in wallet activation, authentication, and transaction process. Additional details on user interactions with manual game controller 100 are shown in FIG. 2A, FIG. 2B, FIG. 3, and FIG. 4.

To ensure security, manual game controller 100 includes an airgap switch 104, which serves as a physical security mechanism to isolate hardware wallet 102 from external connections when not in use. In its default enabled state, the airgap prevents unauthorized access to the cryptographic keys and mitigates security threats. When a user initiates a transaction, they must disable the airgap by toggling airgap switch 104. Upon doing so, an optional indicator light (e.g., biometric ring light 106, an atmospheric light 108, or status light 110) signals the change in status, and manual game controller 100 provides haptic feedback in the form of an unlocking vibration pattern using haptic feedback 112, confirming that hardware wallet 102 is powering on and available for use.

Once airgap switch 104 is toggled, hardware wallet 102 boots up and displays a brand logo (e.g., SHAGA) on a secure display 114 of hardware wallet 102. To complete the authentication process in some embodiments, the system requires biometric verification before enabling transactions. A fingerprint reader 116 is illuminated, prompting the user to place their thumb on a fingerprint sensor pad 118. Upon a successful match, hardware wallet 102 unlocks, and secure display 114 shows an animation of a lock opening, indicating that the wallet is now available for transactions.

As described below, when a user initiates an in-game transaction, such as purchasing a digital asset, the game client prompts the user to connect to the wallet. The transaction details, including an amount, recipient address, and confirmation prompt, are displayed on secure display 114. The user navigates through these transaction details using a right-side back button 120 on manual game controller 100. Once the transaction details have been reviewed, the user is prompted to confirm the transaction using fingerprint authentication on fingerprint sensor pad 118. Upon authentication, hardware wallet 102 signs the transaction using its SE, and the signed transaction is transmitted back to the game client. The game client then processes the transaction and provides an on-screen confirmation message indicating that the transaction was successfully completed.

To maintain wallet security, manual game controller 100 includes an automated airgap reminder feature. If hardware wallet 102 remains active but unused for two minutes, manual game controller 100 prompts the user to re-enable the airgap through a visual reminder on secure display 114 and a pulse of atmospheric light 108. This ensures that the wallet remains protected when not actively in use. Once airgap switch 104 is toggled back to the enabled position, manual game controller 100 provides a locking haptic feedback pattern, signaling that hardware wallet 102 has been powered down and is now isolated from external connections.

The controller-wallet interactions described with reference to FIG. 1 provide several security and usability benefits. Airgap switch 104 ensures that hardware wallet 102 remains disconnected when not in use, preventing unauthorized access. The biometric authentication module in the form of fingerprint reader 116 provides an additional layer of security, ensuring that only the authorized user can access and sign transactions. Secure display 114 allows users to verify transaction details directly on the controller, preventing phishing attacks and reducing reliance on external screens. Additionally, haptic feedback and visual indicators provide real-time confirmation of system states, enhancing the user experience. By integrating these features, manual game controller 100 enables secure, seamless, and user-friendly blockchain and financial transactions while preserving an uninterrupted gaming experience.

Finally, FIG. 1 indicates that left- and right-sides of manual game controller 100 can be separated to swap a removeable center island 122 with a mobile smartphone or display (not shown) held between each controller in landscape orientation. In this example, interior sidewalls of each side are curved to confirm with rounded corners of a smartphone. One of the left- or right-side controller sidewalls includes a USB-C connector (not shown) that plugs into a corresponding receptacle of the smartphone.

FIG. 2A and FIG. 2B illustrate an example process 200 flow for authenticating and authorizing transactions using cryptographic hardware wallet 102 integrated in manual game controller 100. In this example, FIG. 2A and FIG. 2B depict in greater detail a step-by-step user interaction sequence for unlocking hardware wallet 102, performing biometric authentication, and handling transaction approval and fallback authentication mechanisms in case of failed attempts. As explained below, FIG. 2A and FIG. 2B demonstrate a multi-layered security architecture of manual game controller 100, ensuring that only authorized users can access and approve transactions. By integrating biometric authentication, PIN fallback mechanisms, and timeouts with automatic locking, the system mitigates unauthorized access risks while maintaining seamless usability in a gaming environment.

In an initial state 202, when hardware wallet 102 is powered on, a brand logo (e.g., SHAGA) is displayed on secure display 114, indicating that hardware wallet 102 requires authentication before transactions can be processed.

If hardware wallet 102 remains idle for a predefined period (e.g., two minutes), it enters a screensaver or timeout state 204, requiring re-authentication upon reactivation. The user can wake hardware wallet 102 by pressing a biometric authentication button (i.e., fingerprint sensor pad 118) or other configured input located on manual game controller 100.

If fingerprint authentication is already configured, secure display 114 presents a fingerprint icon prompting the user to place their finger on fingerprint sensor pad 118. Upon detection, biometric ring light 106 illuminates, signaling that the fingerprint authentication process has been initiated. The system then verifies whether the provided fingerprint matches the stored biometric credentials.

If fingerprint authentication is successful, a lock animation is displayed on secure display 114, and hardware wallet 102 is unlocked for transactions. The system then confirms that the Shaga app recognizes hardware wallet 102, allowing the transaction process to proceed.

If fingerprint authentication fails (less than three attempts), the system displays an error message and prompts the user to retry authentication.

If three consecutive fingerprint authentication attempts fail, the system falls back to PIN-based authentication 206, requiring the user to enter a secure PIN code.

FIG. 2B shows how, in PIN-based authentication 206, the user navigates a PIN entry interface using back buttons 120 on manual game controller 100. The cursor moves left or right to select numbers, and both back buttons must be pressed together to confirm each digit entry. If the correct PIN code is entered, hardware wallet 102 unlocks, allowing transactions to proceed.

If three consecutive PIN authentication attempts fail, hardware wallet 102 enters a wallet locked state, preventing further authentication attempts until additional security measures are taken (e.g., administrator reset, seed phrase recovery, or additional authentication).

Once authentication is successfully completed, hardware wallet 102 is available for transactions, allowing the user to approve a pending cryptographic transaction via biometric authentication or PIN input. The transaction details, including the amount and recipient address, are displayed on secure display 114, and the user must confirm before hardware wallet 102 signs the transaction using its SE.

FIG. 3 illustrates a process 300 for using an airgap feedback system to facilitate managing a secure connectivity state of hardware wallet 102 within manual game controller 100. For instance, FIG. 3 illustrates an intuitive airgap management system that provides physical security isolation when hardware wallet 102 is not in use. The system further provides immediate user feedback via haptic pulses, atmospheric lights, and on-screen prompts when changing airgap states. Automated timeout-based security nudges ensure that hardware wallet 102 remains protected when inactive, reducing the risk of unauthorized transactions. This approach allows hardware wallet 102 to power on and off with minimal interaction while maintaining strong security. By integrating haptic, visual, and timeout-based security mechanisms, manual game controller 100 ensures a secure and user-friendly method for managing cryptographic transactions without disrupting the gaming experience

In its default state 302, hardware wallet 102 is airgapped, meaning it is physically isolated from external connections. This prevents unauthorized access to cryptographic keys when transactions are not being performed. To initiate a transaction, the user must disable the airgap by toggling airgap switch 104 (or other airgap mechanism) to its off position (which is optionally indicated with a bright caution light or color). Upon doing so, a single pulse haptic feedback event occurs, providing a tactile confirmation that the airgap is being disabled. Hardware wallet 102 then powers on, and secure display 114 activates. A brand logo (e.g., SHAGA) appears on secure display 114, potentially with an animation, indicating that hardware wallet 102 is booting up and becoming available for transactions.

After hardware wallet 102 is ready 304 for transactions (with airgap disabled) and has been idle for a predefined period, such as two minutes, a security mechanism prompts the user to re-enable the airgap. A visual nudge appears on secure display 114, displaying an animated switch graphic signaling the user to toggle airgap switch 104 back to its enabled state. Atmospheric lights 108 pulse, providing an additional visual alert that the airgap remains disabled. Once the user toggles airgap switch 104 back to the on position, a double-pulse haptic feedback event confirms that the airgap is being re-enabled. Atmospheric lights 108 turn off, signaling that hardware wallet 102 is now disconnected from external communication. Hardware wallet 102 powers down, and secure display 114 turns off, confirming that cryptographic operations have been securely terminated.

FIG. 4 shows another process 400 for using an airgap feedback system in manual game controller 100, when the airgap is disabled during a non-Web3 experience. FIG. 4 highlights a security mechanism that ensures hardware wallet 102 remains active only when necessary, reducing potential exposure to unauthorized transactions while maintaining a seamless user experience. By integrating multimodal feedback, including haptic vibrations, visual alerts, and automatic prompts, manual game controller 100 ensures that users are aware of the airgap status and can take action when necessary to maintain security during non-Web3 experiences. In other words, FIG. 4 demonstrates an example of how the system handles airgap states when hardware wallet 102 is not actively needed for blockchain transactions.

In its default state 402, hardware wallet 102 remains airgapped, ensuring cryptographic isolation from external connections. If the user toggles airgap switch 104 to disable the airgap, a triple pulse haptic feedback event occurs, signaling the change in status. Simultaneously, atmospheric lights 108 pulse, providing a visual cue to indicate that the airgap has been disabled.

Once the airgap is disabled, hardware wallet 102 powers on and displays an animation nudging the user to enable the airgap if the controller is being used in a non-Web3 application. Secure display 114 may show an “unsupported” message, indicating that blockchain-related functions are not required in the current usage mode. In some embodiments, this animation may be customizable to match branding or feature updates.

If the user enables the airgap again by toggling airgap switch 104 back to the enabled state, a double pulse haptic feedback event confirms that the airgap is being re-engaged. Simultaneously, atmospheric lights 108 turn off, providing additional confirmation that the wallet is now isolated from external connections. Once the airgap is fully enabled, hardware wallet 102 powers down, and secure display 114 turns off, preventing unauthorized access to cryptographic keys or transaction signing capabilities.

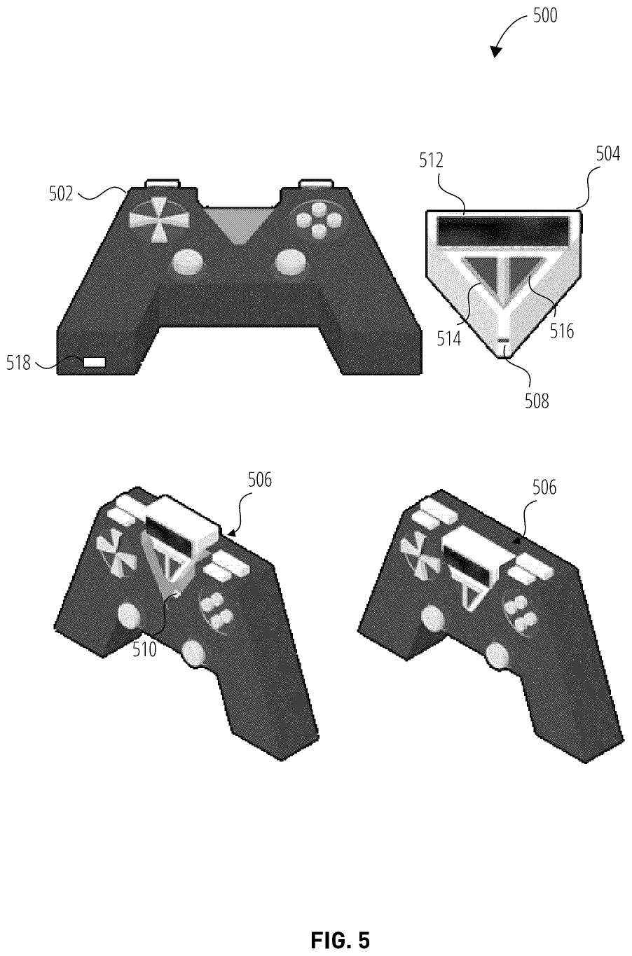

FIG. 5 shows a gamepad system 500 according to one embodiment that includes a gamepad 502 and a removable hardware wallet module 504. In this example, removable hardware wallet module 504 is shown removed from gamepad 502 (top left and right) and slidably installed into a wallet receiving port 506 of gamepad 502 (bottom left and right). In light of this disclosure, skilled persons will appreciate that the security afforded by electrically isolating removable hardware wallet module 504 may be implemented in other ways as well. For instance, another embodiment of the wallet may be electrically disconnected by electrical or mechanical switches or connectors, optical isolators, or any other means by which to disconnect hardware wallet 504.

Removable hardware wallet module 504 includes a connection port 508 to receive an electrical connector 510 (e.g., USB-C) of gamepad 502. An optional battery is included in the housing of removable hardware wallet module 504.

Removable hardware wallet module 504 also includes secure display 512 to facilitate crypto transactions. In some embodiments, secure display 512 is a limited-resolution LED pixel display (so as to frustrate attempts to superimpose fraudulent transaction details on a full resolution display). For instance, a hardware wallet display typically utilizes OLED or simple LED technology, focusing on displaying basic information clearly and efficiently. These displays are small, monochrome or limited in color, and designed to consume very low power. Hardware wallet displays are typically not touch-sensitive.

To navigate and respond to secure display 512 prompts and menus, removable hardware wallet module 504 includes a left button 514 and a right button 516. Each button 514 and 516 may be pressed independently from the other to move left or right through menu text presented on secure display 512. Buttons 514 and 516 may be pressed simultaneously to make a selection (e.g., sign a blockchain transaction).

Removable hardware wallet module 504 also includes an SE. An SE is a specialized, tamper-resistant chip designed to securely store cryptographic keys and personal data. One example is the EdgeLock® SE050, available from NXP. In hardware wallets, the SE ensures that the private keys used to sign cryptocurrency transactions cannot be extracted or compromised, even if the device is connected to a compromised computer. This adds an additional layer of security to the hardware wallet's functionality that helps protect sensitive data, such as private keys, seed phrases, and other cryptographic information.

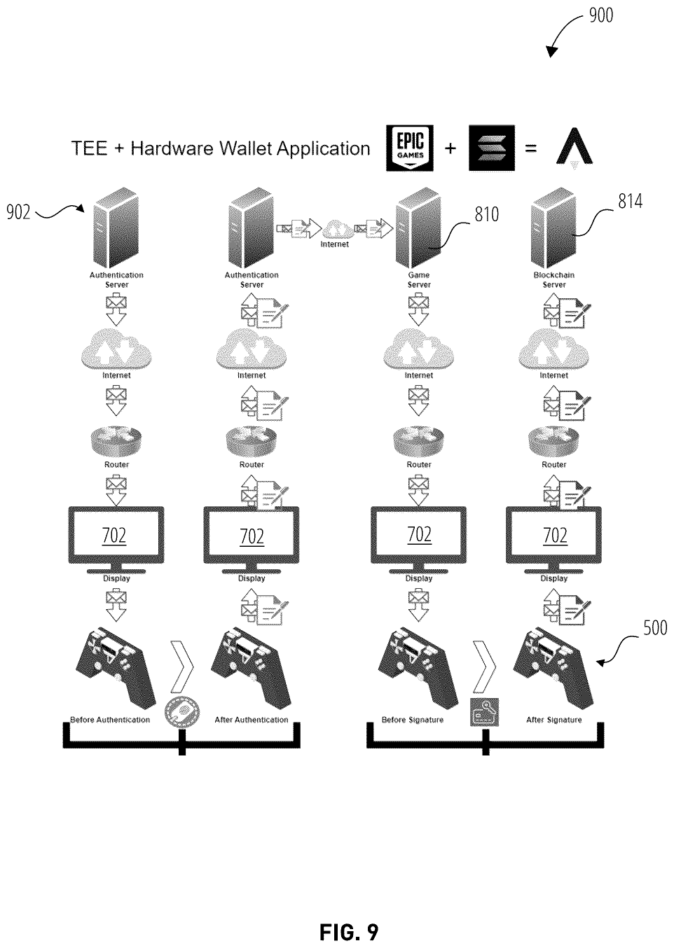

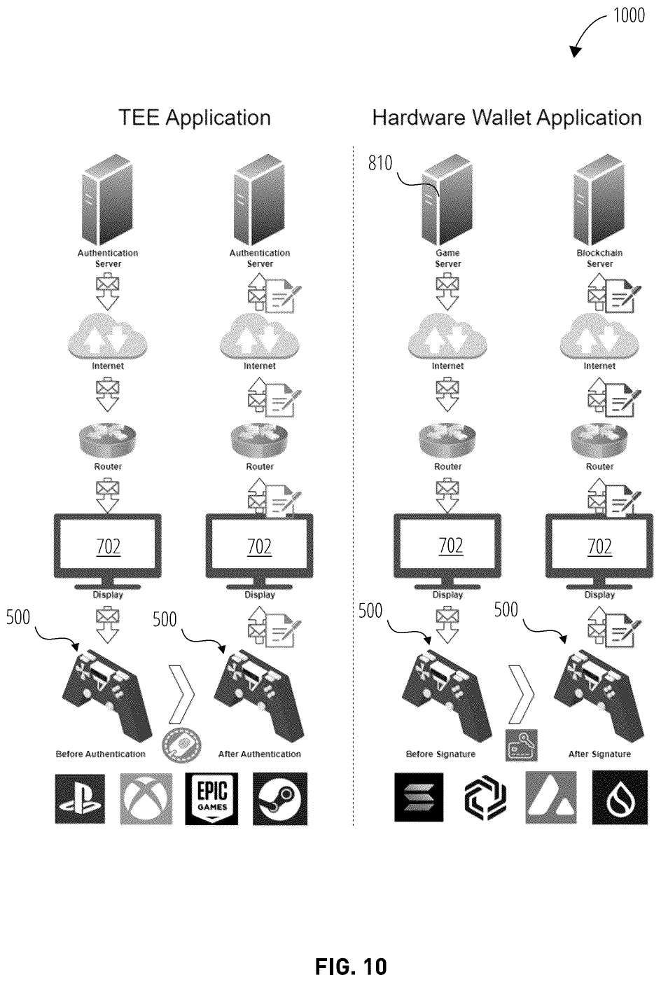

Gamepad 502 or removable hardware wallet module 504 also include a TEE. A TEE is a secure area within a computer's central processing unit (CPU) designed to protect sensitive data and code execution from the rest of the device's operating system and applications. It ensures that the data processed within the TEE remains confidential and intact, providing a high level of security against unauthorized access and software attacks. In the context of gamepad system 500, the TEE is utilized with biometric data to facilitate authentication (see, e.g., FIG. 9 and FIG. 10). By storing and processing biometric information such as fingerprints, facial recognition data, or iris scans within the TEE, it ensures that this sensitive information is protected from malicious software and hackers. The isolation provided by a TEE makes it a suitable environment for handling such data, offering a secure way to authenticate users without exposing their biometric details to the less secure parts of a device's ecosystem.

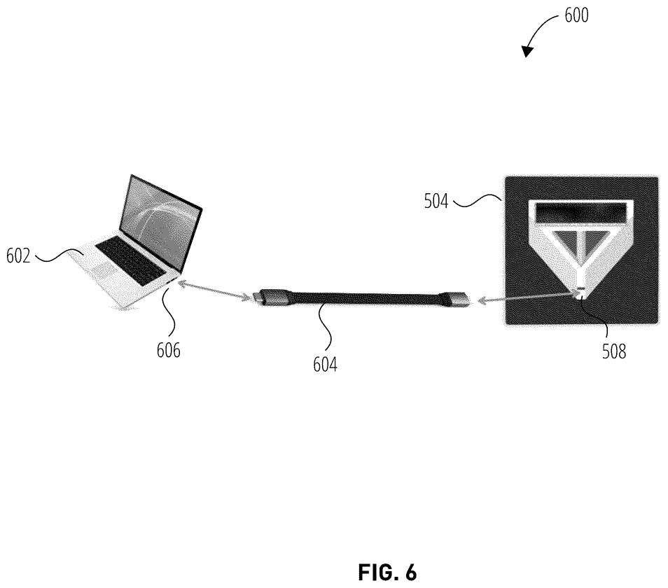

FIG. 5 also includes a port 518 for connecting another hardware wallet (not shown) using a tether cable (see, e.g., FIG. 6). In this configuration, the other hardware wallet can be used instead of removable hardware wallet module 504. In this example, the user keeps a switch turned off (e.g., disconnecting removable hardware wallet module 504), when the user plugs in the external wallet. In other examples, an internal mechanical switch engages or disengages depending on whether removable hardware wallet module 504 is slidably installed, or whether an external hardware wallet is connected to port 518. Once the switch is turned on, gamepad 502 may also check port 518 first for a connection, and if it is not connected, then transactions are sent to and from removable hardware wallet module 504 in cooperation with a game client. The user would know which wallet is being transacted with according to its secure display and information presented by the game client (e.g., showing an address for the hardware wallet).

When removed, removable hardware wallet module 504 is available to operate as a traditional hardware wallet to complete transactions in another gamepad (not shown) or use assets associated with cryptographic keys of removable hardware wallet module 504. For example, FIG. 6 shows a laptop system 600 including a laptop 602, tether cable 604, and removable hardware wallet module 504. When tether cable 604 connects connection port 508 to a laptop port 606, the cryptographic keys in removable hardware wallet module 504 may be used to authenticate transactions for a user of laptop 602.

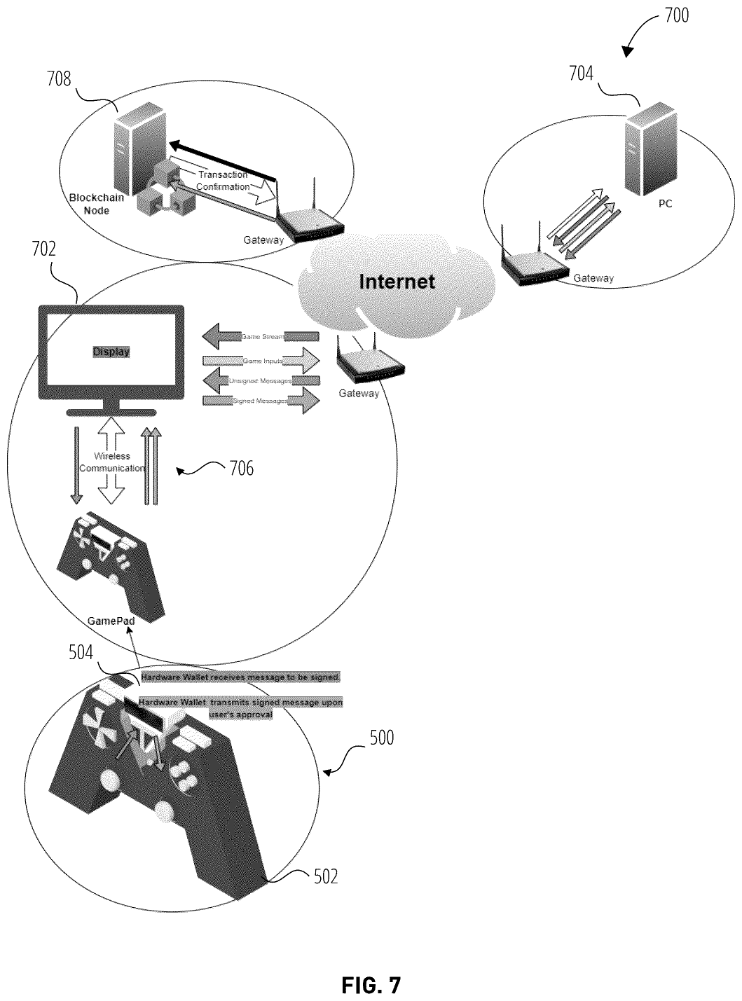

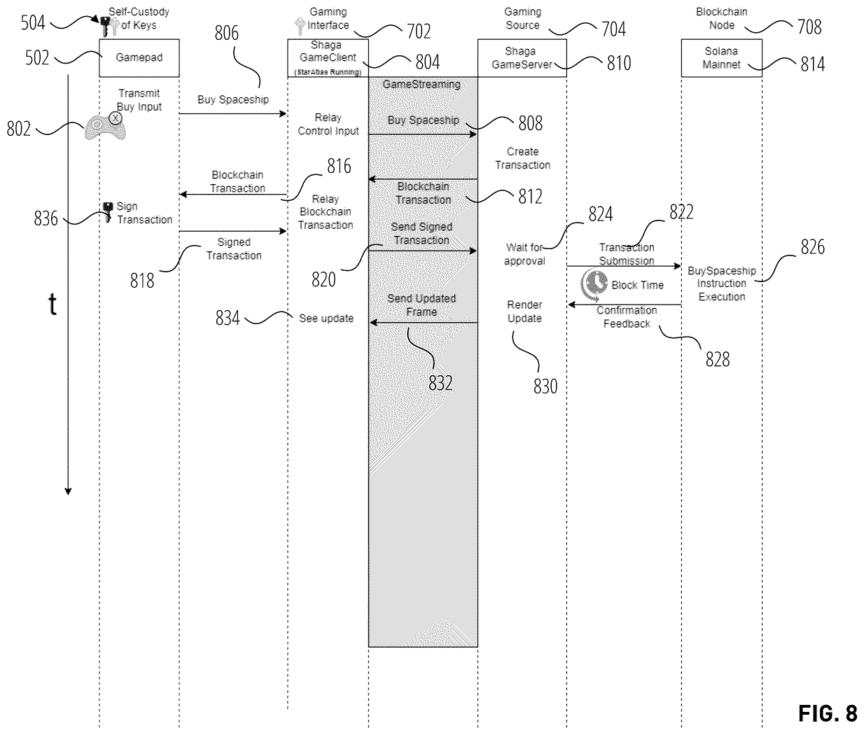

FIG. 7 shows a Web3 game streaming system 700 in use for Web3 game streaming. Web3 game streaming system 700 includes a gaming user interface display 702 such as a smart TV display executing a game client (see, e.g., FIG. 8) for streaming a video game from a gaming source 704 acting as a game server (FIG. 8). In other embodiments, gaming user interface display 702 need not stream the game but instead may act as the game host itself.

Gaming user interface display 702 and gamepad system 500 share a wireless interface 706 through which game inputs are provided to gaming user interface display 702 and gaming source 704. An example wireless interface 706 includes a wireless personal area network connection, provided via Bluetooth, Wi-Fi Direct, or similar technology. Skilled persons will appreciate in light of this disclosure that a wired interface (e.g., USB) or any other communication interface may also be employed between gamepad system 500 and gaming user interface display 702.

Wireless interface 706 also allows for completing crypto transactions with a blockchain node 708 in a manner that would otherwise be impossible or would compromise the user's security. For instance, in this example of FIG. 7, gamepad system 500 is enabling Web3 game streaming with full self-custody of the keys involved for blockchain interactions (annotated in orange and green colors). Additional details on the operation of Web3 game streaming system 700 are provided with reference to FIG. 8.

FIG. 8 shows an example of how gamepad system 500 is employed to complete crypto transactions. In this example, a user sees a spaceship he or she wants to purchase. Initially, a user pressed 802 X on gamepad 502 to purchase a spaceship that was presented on gaming user interface display 702 executing a game client 804 for streaming a game. Controller input signal 806 is sent to gaming user interface display 702.

Game client 804 on gaming user interface display 702 relays 808 controller input signal 806 to a game server 810, which is on the gaming source (node/gamer PC). This transports controller input signal 806 to game server 810, which interprets controller input signal 806 as an instruction to buy the spaceship.

Game server 810 then initiates a blockchain transaction 812 intended to buy the spaceship NFT. A blockchain transaction on Solana 814 is a structured message (including a set of instructions), which is a data packet for modifying the state of the NFT and modifying Solana state. When there is a transaction, there is a new state to be written on the blockchain. Blockchain transaction 812 is then transmitted to game client 804 from game server 810.

Game client 804 receives blockchain transaction 812 and relays 816 it to gamepad 502.

Gamepad 502, using removable hardware wallet module 504 that is engaged (e.g., a switch on gamepad 502 has electrically connected removable hardware wallet module 504), presents on secure display 512 (FIG. 5) the details of blockchain transaction 812 so that the user can accept (e.g., press both left button 514 and right button 516 simultaneously) and thereby sign blockchain transaction 812. In other words, removable hardware wallet module 504 on gamepad 502 receives the transaction unsigned, and allows for signing that. Gamepad 502 transmits signed blockchain transaction 818 back to gaming user interface display 702 now that the transaction is filled with the necessary signatures.

Next, game client 804 sends 820 signed blockchain transaction 818 to game server 810. In some embodiments, this entails adding the IP address of game server 810 to the control data from gamepad 502.

Game server 810 then generates a blockchain transaction submission 822 while it waits 824 for approval. In general, the transaction is being submitted to an RPC node that is later submitting the transaction to a validator and then getting feedback from the validator updating the state that the transaction wanted to modify.

Solana 814 then will perform a buy spaceship instruction execution 826. There is blockchain data that is modified, such that the spaceship NFT is transferred from one account to another account (the buyer's account).

Confirmation feedback 828: This is a response to the server from the blockchain RPC node. It is detailed on the Solana website: https://solana.com/docs/core/transactions/confirmation

Render update 830: Here the blockchain transaction confirmation is received to the server and the game state is updated, meaning the player can start using the Star Atlas spaceship.

Send updated frame 832: Here, after the game state is updated, the frame is buffered from the GPU and it is encoded and transmitted to game client 804 (e.g., using GameStream protocol, Moonlight).

See update 834: The user sees that his or her transaction went through and how, instead of a big blue button that says “purchase” on the screen next to the spaceship, the user went through the process to purchase such that the big blue button is now green, and it says “owned.”

The combination of removable hardware wallet module 504 and gamepad 502 allows for storage of cryptographic keys and authentication data. FIG. 9 shows an example of information flow 900 for Web3 game streaming where the TEE in gamepad 502 is used to authenticate the user and have him access his Web2 account, and removable hardware wallet module 504 is used to sign transactions in a Web3 account. The process is as follows.

First, the user authenticates on an authentication server 902 of the Web2 platform (here, Epic Games). Second, the user may start signing blockchain transactions related to their Web3 accounts (here, Solana). An example for this is Star Atlas, a Web3 Game hosted on the Epic Games Launcher.

FIG. 10 shows another example of an information flow 1000, in which the TEE may be used completely independently of any blockchain transactions. In this example, gamepad 502 is capable of connecting remotely to any PC, via an application executed in gaming user interface display 702 (e.g., a smart TV) and logging in with the user's own account. An example is signing in to Epic Games with gamepad 502, without needing to remember passwords or usernames.

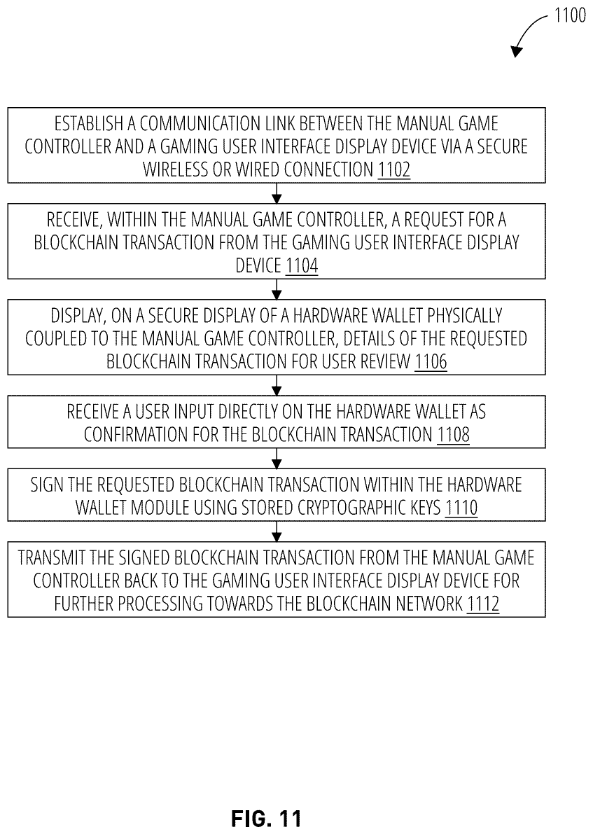

FIG. 11 shows a process 1100 for enabling secure blockchain transactions in a gaming environment, performed by a manual game controller. In block 1102, process 1100 establishes a communication link between the manual game controller and a gaming user interface display device via a secure wireless or wired connection. In block 1104, process 1100 receives, within the manual game controller, a request for a blockchain transaction from the gaming user interface display device. In block 1106, process 1100 displays, on a secure display of a hardware wallet physically coupled to the manual game controller, details of the requested blockchain transaction for user review. In block 1108, process 1100 receives a user input directly on the hardware wallet as confirmation for the blockchain transaction. In block 1110, process 1100 signs the requested blockchain transaction within the hardware wallet module using stored cryptographic keys. In block 1112, process 1100 transmits the signed blockchain transaction from the manual game controller back to the gaming user interface display device for further processing towards the blockchain network.

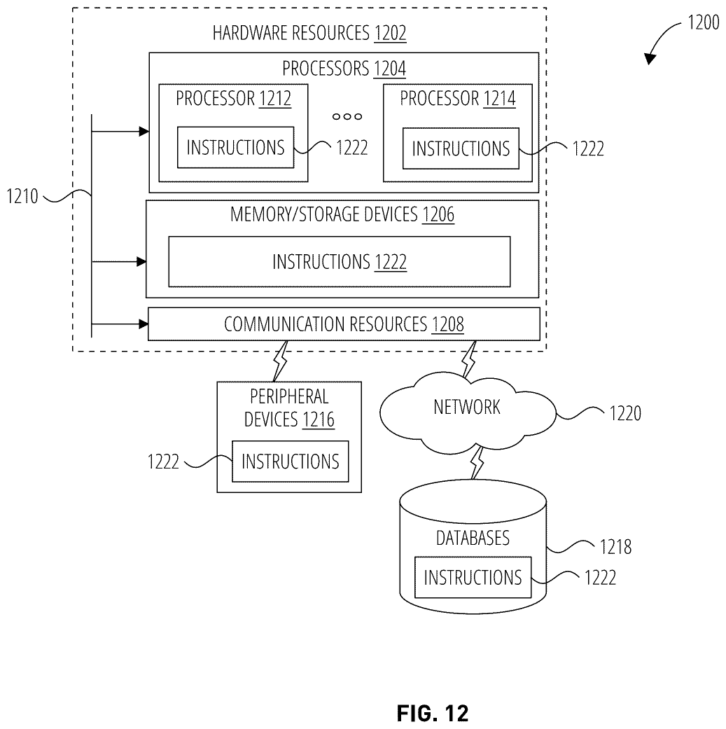

FIG. 12 is a block diagram illustrating components 1200, according to some example embodiments, able to read instructions from a machine-readable or computer-readable medium (e.g., a non-transitory machine-readable storage medium), and perform any one or more of the processes discussed herein (e.g., FIG. 8 or FIG. 11). For example, hardware resources 1202 may be embodied in a smartwatch, server, tablet computer, or manual game controller.

Specifically, FIG. 12 shows a diagrammatic representation of hardware resources 1202 including one or more processors 1204 (or processor cores), one or more memory/storage devices 1206, and one or more communication resources 1208, each of which may be communicatively coupled via a bus 1210.

Processors 1204 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), another processor, or any suitable combination thereof) may include, for example, a processor 1212 and a processor 1214.

Memory/storage devices 1206 may include main memory, disk storage, or any suitable combination thereof. Memory/storage devices 1206 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

Communication resources 1208 may include interconnection or network interface components or other suitable devices to communicate with one or more peripheral devices 1216 or one or more databases 1218 via a network 1220. For example, communication resources 1208 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1222 may comprise software, a program, an application, an applet, an app, or other executable code for causing at least any of processors 1204 to perform any one or more of the processes discussed herein. In some embodiments, instructions 1222 include singing crypto transactions.

Instructions 1222 may reside, completely or partially, within at least one of processors 1204 (e.g., within the processor's cache memory), memory/storage devices 1206, or any suitable combination thereof. Furthermore, any portion of instructions 1222 may be transferred to hardware resources 1202 from any combination of peripheral devices 1216 or databases 1218. Accordingly, memory of processors 1204, memory/storage devices 1206, peripheral devices 1216, and databases 1218 are examples of computer-readable and machine-readable media.

Skilled persons will appreciate that many changes may be made to the details of the above-described embodiments without departing from the underlying principles of the invention. The scope of the present invention should, therefore, be determined only by claimed inventions and equivalents thereof.

What is claimed is:

1. A manual game controller, comprising:
a housing configured to retain a hardware wallet, in which the hardware wallet comprises a secure element for storing cryptographic keys and is disconnectably coupled to the manual game controller for facilitating a communications airgap;
a communication interface configured to transmit game inputs to a user interface display and to facilitate cryptographic transactions by signing transaction data within the secure element before transmitting a signed transaction; and
a biometric authentication sensor communicatively coupled to the hardware wallet, in which the biometric authentication sensor is required to authorize the cryptographic transaction before the transaction is signed by the hardware wallet.

2. The manual game controller of claim 1, further comprising an airgap switch that electrically disconnects the hardware wallet.

3. The manual game controller of claim 1, further comprising a fingerprint reader for wallet authorizations.

4. The manual game controller of claim 1, in which the hardware wallet is removable from a slot in the housing.

5. The manual game controller of claim 1, in which the hardware wallet is integrated in the housing.

6. The manual game controller of claim 1, in which the hardware wallet includes a TEE.

7. The manual game controller of claim 1, further comprising a TEE that is separate from the hardware wallet.

8. The manual game controller of claim 1, including a secure display in the hardware wallet.

9. A method for enabling secure blockchain transactions in a gaming environment, performed by a manual game controller, the method comprising:
establishing a communication link between the manual game controller and a gaming user interface display device via a secure wireless or wired connection;
receiving, within the manual game controller, a request for a blockchain transaction from the gaming user interface display device;
displaying, on a secure display of a hardware wallet physically coupled to the manual game controller, details of the requested blockchain transaction for user review;
receiving a user input directly on the hardware wallet as confirmation for the blockchain transaction;
signing the requested blockchain transaction within the hardware wallet module using stored cryptographic keys; and
transmitting the signed blockchain transaction from the manual game controller back to the gaming user interface display device for further processing towards the blockchain network.

10. The method of claim 9, in which the manual game controller utilizes the secure display to provide feedback to the user regarding the outcome of the blockchain transaction.

11. The method of claim 9, further comprising:
receiving, within the manual game controller, a request for an authentication of a user from the gaming user interface display device; and
securely processing the authentication of the user without exposing login credentials to external devices or networks using a trusted execution environment (TEE).

12. The method of claim 11, in which the TEE is available in the hardware wallet.

13. The method of claim 9, in which the hardware wallet module includes a secure element chip for tamper-resistant storage of the cryptographic keys and is capable of being detached from the manual game controller for independent use or for facilitating secure transactions on additional compatible devices.

14. The method of claim 9, in which the manual game controller further comprises a biometric authentication sensor, and in which the biometric authentication sensor is required to authenticate a user before signing the blockchain transaction.

15. The method of claim 9, in which the hardware wallet is initially airgapped for a user to disable an airgap switch before the blockchain transaction request can be processed.

16. The method of claim 9, further comprising automatically re-enabling the airgap security mechanism upon completion of the cryptographic transaction.

17. The method of claim 9, further comprising providing haptic feedback through the manual game controller and visual feedback on the hardware wallet's secure display when the airgap is toggled on or off.

18. The method of claim 9, in which the secure display of the hardware wallet provides a step-by-step transaction review, including an amount of cryptocurrency involved, recipient address, and a sign transaction prompt requiring user confirmation.

19. The method of claim 9, in which the cryptographic signing of the blockchain transaction is performed within a secure element of the hardware wallet, ensuring private keys are not exposed to an operating system of the manual game controller.

20. The method of claim 9, in which the hardware wallet is further configured to store and sign Web2 authentication credentials, allowing a user to log into a gaming platform or online account securely.

21. The method of claim 9, in which the hardware wallet is configured to store and sign non-blockchain cryptographic credentials, including digital identity keys, gaming platform authentication tokens, and encrypted session keys.
